(19) United States
(12) Patent Application Publication
(10) Pub. No.: US 2005/0189744 A1
(43) Pub. Date: Sep. 1, 2005

(54) Inflatable curtain with open ended fill tube

(75) Inventors: Kwen Hsu, Rochester Hills, MI (US); Ayad G. Nayef, Sterling Heights, MI (US); Jeffrey S. Aird, Rochester, MI (US); Ali Emam Bakhsh, Rochester Hills, MI (US); Al A. Saberan, New Baltimore, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/790,523

(22) Filed: Mar. 1, 2004

(51) Int. Cl. B60R 21/22

(52) U.S. Cl. 280/730.2

(57) ABSTRACT

An apparatus (10) for helping to protect an occupant of a vehicle (12) that has a side structure (16) and a roof (18) includes an inflatable curtain (14). The inflatable curtain (14) includes a front portion (74) and a rear portion (76). The inflatable curtain (14) is inflatable away from the vehicle roof (18) to a position adjacent the side structure (16). An inflation fluid source (24) provides inflation fluid for inflating the inflatable curtain (14). A fill tube (22) directs inflation fluid from the inflation fluid source (24) into the inflatable curtain (14). The fill tube (22) has a portion (38) that extends into one of the front and rear portions (74 and 76) and terminates in the one of the front and rear portions. The fill tube (22) also has an open end portion (110) for directing inflation fluid to flow axially from the fill tube into the inflatable curtain (14) and at least one aperture (112) for directing inflation fluid to flow generally radially from the fill tube into the inflatable curtain.

### FIELD OF THE INVENTION

The present invention relates to an inflatable apparatus for helping to protect a vehicle occupant in the event of a side impact to the vehicle and/or a vehicle rollover.

### BACKGROUND OF THE INVENTION

It is known to inflate an inflatable vehicle occupant protection device to help protect a vehicle occupant. One particular type of inflatable vehicle occupant protection device is an inflatable curtain. The inflatable curtain is inflatable away from the roof of t he vehicle between a vehicle occupant and the side structure of the vehicle in response to a side impact to the vehicle and/or a vehicle rollover. A known inflatable curtain is inflated from a deflated condition with inflation fluid directed from an inflator to the inflatable curtain.

### SUMMARY OF THE INVENTION

The present invention relates to an apparatus for helping to protect an occupant of a vehicle that has a side structure and a roof. The apparatus includes an inflatable curtain. The inflatable curtain includes a front portion and a rear portion. The inflatable curtain is inflatable away from the vehicle roof to a position adjacent the side structure. An inflation fluid source provides inflation fluid for inflating the inflatable curtain. A fill tube directs inflation fluid from the inflation fluid source into the inflatable curtain. The fill tube has a portion that extends into one of the front and rear portions and terminates in the one of the front and rear portions. The fill tube also has an open end portion for directing inflation fluid to flow axially from the fill tube into the inflatable curtain and at least one aperture for directing inflation fluid to flow generally radially from the fill tube into the inflatable curtain.

The present invention also relates to an apparatus including an inflatable curtain that is inflatable away from a roof of a vehicle to a position adjacent a side structure of the vehicle. The inflatable curtain includes at least one inflatable first chamber inflatable between the side structure and one of the front and rear seating of the vehicle. The inflatable curtain also includes at least one inflatable second chamber inflatable between the side structure and the other of the front and rear seating. The inflatable curtain further includes a non-inflatable portion positioned between the first and second chambers and a passage providing fluid communication between the first and second chambers. An inflation fluid source provides inflation fluid for inflating the inflatable curtain. A fill tube directs inflation fluid from the inflation fluid source into the inflatable curtain. The fill tube has a portion extending into the at least one second chamber and terminating in the at least one second chamber. The fill tube has an open end portion opposite the inflation fluid source for directing inflation fluid through the passage into the at least one first chamber. The fill tube also includes at least one aperture for directing inflation fluid in a generally downward direction into the at least one second chamber.

The present invention also relates to an apparatus for helping to protect an occupant of a vehicle that has a side structure and a roof. The apparatus includes an inflatable curtain that is inflatable away from the vehicle roof to a position adjacent the side structure of the vehicle. The inflatable curtain comprises at least one inflatable front chamber inflatable between the side structure and a front seated occupant of the vehicle. The inflatable curtain also comprises at least one inflatable rear chamber inflatable between the side structure and a rear seated occupant of the vehicle. A non-inflatable portion is positioned between the front and rear chambers and a passage provides fluid communication between the front and rear chambers. An inflation fluid source provides inflation fluid for inflating the inflatable curtain and a fill tube directs inflation fluid from the inflation fluid source into the inflatable curtain. The fill tube extends from the inflation fluid source into the rear chamber(s) and terminates in the rear chamber(s). The fill tube has an open end portion opposite the inflation fluid source for directing inflation fluid through the passage into the front chamber(s). The fill tube also has at least one aperture for directing inflation fluid in a generally downward direction into the rear chamber(s).

The present invention further relates to an apparatus for helping to protect an occupant of a vehicle that has a side structure and a roof. The apparatus includes an inflatable curtain that is inflatable away from the vehicle roof to a position adjacent the side structure of the vehicle. An inflation fluid source provides inflation fluid for inflating the inflatable curtain. A fill tube directs inflation fluid from the inflation fluid source into the inflatable curtain. The fill tube has an open end portion for directing an axial flow of inflation fluid from the fill tube into the inflatable curtain. The fill tube also includes at least one aperture for directing a generally radial flow of inflation fluid from the fill tube to help reduce pressure drop in the inflatable curtain induced by the axial flow of inflation fluid from the open end portion.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant illustrating the apparatus in a deflated condition in a vehicle, according to the present invention; and

FIG. 2 is a schematic view of the apparatus of FIG. 1 in an inflated condition in the vehicle.

### DESCRIPTION OF AN EMBODIMENT

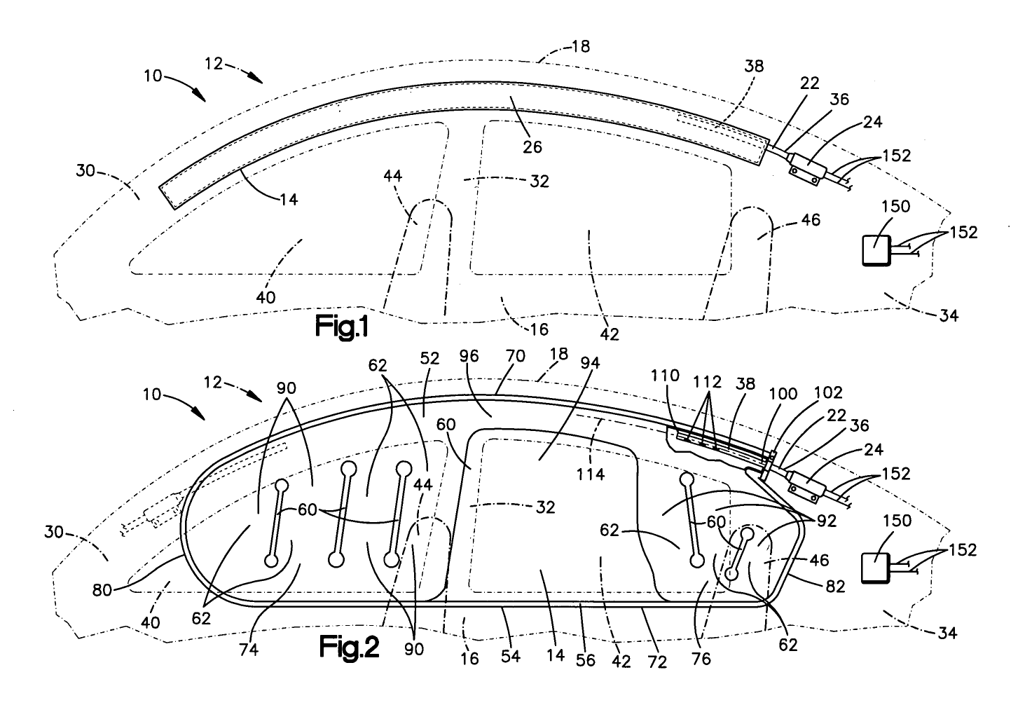

Representative of the present invention, an apparatus 10 helps to protect an occupant of a vehicle 12. As shown in FIGS. 1 and 2, the apparatus 10 includes an inflatable vehicle occupant protection device in the form of an inflatable curtain 14 that is mounted adjacent the side structure 16 of the vehicle 12 and the roof 18 of the vehicle. The side structure 16 of the vehicle 12 includes an A pillar 30, a B pillar 32, a C pillar 34, and front and rear side windows 40 and 42. The vehicle 12 also includes front vehicle seating 44 positioned adjacent the front side window 40 and rear vehicle seating 46 positioned adjacent the rear side window 42.

An inflator 24 is connected in fluid communication with the inflatable curtain 14 through a fill tube 22. The fill tube 22 may be constructed of any suitable material, such as metal or plastic. The fill tube 22 has a first end portion 36 for receiving fluid from the inflator 24. The fill tube 22 may be connected directly to the inflator 24 or a manifold (not shown) may connect the fill tube to the inflator. The fill tube 22 has a second end portion 38 disposed in the inflatable curtain 14.

The inflator 24 contains a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 may include a housing 26 (FIG. 1) that stores the inflatable curtain 14 in a stored and deflated condition. The deflated inflatable curtain 14 and the housing 26 have an elongated configuration and extend along the vehicle roof 18 and along the side structure 16 of the vehicle 12 above the side windows 40 and 42. The inflatable curtain 14 and housing 26 may be connected to the vehicle 12 by known means (not shown), such as brackets.

The inflatable curtain 14 (FIG. 2) includes panels 52 of material that are arranged in an overlying manner. Overlapping portions of the panels 52 are interconnected along at least a portion of a perimeter 54 of the inflatable curtain 14 to form a perimeter connection 56 of the curtain. The perimeter connection 56 helps define an inflatable volume of the inflatable curtain 14.

The inflatable curtain 14 may also include interior connections 60 through which the overlying panels 52 are interconnected within the perimeter 54 of the curtain. The interior connections 60 form non-inflatable portions of the inflatable curtain 14 within the perimeter 54 of the curtain. The interior connections 60 also help define inflatable chambers 62 of the inflatable curtain 14. The configuration of the interior connections 60, and thus the chambers 62, may vary depending on a variety of factors, such as the architecture of the vehicle 12, the position of the inflatable curtain 14 in the vehicle, and the desired extent or coverage of the inflatable curtain.

The perimeter connection 56 and the interior connections 60 may be formed in a variety of manners, such as by interweaving the overlying panels 52, stitching the panels together, or interconnecting the panels via ultrasonic welding, heat bonding, or adhesives. In a woven construction, the overlying panels 52 may be woven/interwoven simultaneously from a material, such as nylon yarn, and may be coated with a gas impermeable material, such as urethane, or laminated with a gas impermeable film. The inflatable curtain 14 thus may have a substantially gas-tight construction. Those skilled in the art will appreciate that alternative materials, such as polyester yarn, and alternative coatings, such as silicone, may also be used to construct the inflatable curtain 14.

The perimeter 54 of the inflatable curtain 14 is defined at least partially by an upper edge 70, an opposite lower edge 72 of the curtain, and front and rear portions 74 and 76, respectively, of the inflatable curtain spaced apart horizontally along the upper and lower edges. The front and rear portions 74 and 76 of the inflatable curtain 14 include front and rear edges 80 and 82, respectively, that are spaced horizontally apart and extend between the upper and lower edges 70 and 72.

The front portion 74 of the inflatable curtain 14 includes one or more inflatable front chambers 90 defined at least partially by the perimeter connection 56 and some of the interior connections 60. In the embodiment illustrated in FIG. 2, the front chambers 90 extend generally parallel with each other in a generally vertical direction in the vehicle 12. The rear portion 76 of the inflatable curtain 14 includes one or more inflatable rear chambers 92 defined at least partially by the perimeter connection 56 and some of the interior connections 60. In the embodiment illustrated in FIG. 2, the rear chambers 92 extend generally vertically or diagonally in the vehicle 12.

The front and rear portions 74 and 76, and thus the front and rear chambers 90 and 92, are separated by a relatively large non-inflatable middle portion 94 of the inflatable curtain 14 formed by one of the interior connections 60. The middle portion 94 helps define a passage 96 that provides fluid communication between the front and rear portions 74 and 76 and between the front and rear chambers 90 and 92. The passage 96 extends above the middle portion 94 along the upper edge 70 of the inflatable curtain.

The second portion 38 of the fill tube 22 extends into the rear portion 76 of the inflatable curtain 14 and terminates in the rear portion of the curtain. The fill tube 22 enters the inflatable curtain 14 through a neck portion 100 of the curtain located at or near the intersection of the upper edge 70 and rear edge 82 of the curtain. The neck portion 100 may be secured to the fill tube 22 by means 102, such as a clamp, which may also help prevent leakage of inflation fluid through the neck portion.

The vehicle 12 includes a sensor mechanism 150 (shown schematically in FIGS. 1 and 2) for sensing the occurrence of an event for which inflation of the inflatable curtain 14 is desired, such as a side impact to the vehicle 12 and/or a vehicle rollover. Upon sensing the occurrence of such an event, the sensor mechanism 150 provides an electrical signal over lead wires 152 to the inflator 24. The electrical signal causes the inflator 24 to be actuated in a known manner. The inflator 24 discharges fluid under pressure through fill tube 22, which directs the fluid into the inflatable curtain 14.

The inflatable curtain 14 inflates under the pressure of the inflation fluid from the inflator 24. The inflatable curtain 14 inflates away from the roof 18 in a downward direction as shown in the drawings and in a downward direction with respect to the direction of forward travel of the vehicle 12 into the position illustrated in FIG. 2.

The inflatable curtain 14, when inflated, extends along the side structure 16 of the vehicle 12 and is positioned between the side structure and any occupant of the vehicle. The inflatable curtain 14 covers portions of the vehicle side structure that extend between the A pillar 30 and the C pillar 34 of the vehicle 12 and may overlie portions of the A pillar, C pillar, and the B pillar 32 of the vehicle. The front portion 74 and the front chambers 90 of the inflatable curtain 14, when inflated, may be positioned between the vehicle side structure 16 and the front vehicle seating 44. The rear portion 76 and the rear chambers 92, when inflated, may be positioned between the vehicle side structure 16 and the rear vehicle seating 46.

Those skilled in the art will appreciate that the extent and coverage of the inflatable curtain 14 in the vehicle 12 may vary. For example, the extent and coverage of the inflatable curtain 14 may vary depending on a variety of factors, such as the architecture of the vehicle 12, the position of the inflatable curtain 14 in the vehicle, and the desired extent or coverage of the inflatable curtain.

The inflatable curtain 14, when inflated, helps to protect a vehicle occupant in the event of a vehicle rollover or a side impact to the vehicle 12. The inflatable curtain 14 may cover an area of the side structure 16 extending from the A pillar 30 to the C pillar 34 and from the roof 18 down to adjacent or below the side windows 40 and 42. The inflatable curtain 14, when inflated, helps to absorb the energy of impacts with the curtain and helps to distribute the impact energy over a large area of the curtain.

According to the present invention, the second end portion 38 of the fill tube 22 may extend into and along a substantial portion of the length of the rear portion 76 of the inflatable curtain 14, as measured horizontally in FIG. 2. The second end portion 38 may, for example, extend at least 25-75% of the length of the rear portion 76.

The fill tube 22 includes an open end portion 110 and at least one aperture 112 for directing inflation fluid from the fill tube into the inflatable curtain 14. The length of the second end portion 38 may be sufficient to place the open end portion 110 near the passage 96, as shown in FIG. 2. The open end portion 110 may thus direct inflation fluid from the fill tube 22 in a direction generally parallel to a longitudinal axis 114 of the fill tube into the passage 96. Also, because the second end portion 38 is positioned within in the rear portion 76, the apertures 112 may direct inflation fluid from the fill tube 22 in directions transverse or generally radial or perpendicular to the axis 114 downward into the rear chambers 92.

The open end portion 110 directs inflation fluid from the fill tube 22 through the passage 96 and into the front portion 74 of the inflatable curtain 14 to inflate the front chambers 90 of the curtain. The apertures 112 direct inflation fluid from the fill tube 22 into the rear portion 76 of the inflatable curtain 14 to inflate the rear chambers 92 of the curtain.

As shown in FIG. 2, the front and rear portions 74 and 76 may have different inflatable volumes. Therefore, it may be desirable to direct inflation fluid into the front and rear portions 74 and 76 at different flow rates (i.e., volumetric or mass flow rate) in order to inflate the front and rear chambers 90 and 92 to a desired pressure in a required amount of time. The size, number and spacing of the apertures 112 of the fill tube 22 and the diameter of the fill tube may be selected so as achieve these required volumetric flow rates into the front and rear portions 74 and 76 of the inflatable curtain 14.

For example, in the embodiment illustrated in FIG. 2, the front portion 74 may have a larger inflatable volume than the rear portion 76. In this instance, the diameter of the fill tube 22 and the size and number of apertures 112 may be selected so that the flow rate at which inflation fluid is directed toward the front portion 74 by the open end portion 110, is greater than the flow rate at which inflation fluid is directed toward the rear portion 76 by the apertures 112. The flow rate through the open end portion 110 and the apertures 112 may be proportional to the respective portions of the overall inflatable volume of the inflatable curtain 14 occupied by the front and rear portions 74 and 76. In this way, the front and rear portions 74 and 76 of the inflatable curtain 14 may be inflated and deployed evenly along the length of the curtain and may be inflated to the desired-pressure within the desired time period.

The fill tube 22, extending into the rear portion 76 and including the apertures 112, also helps prevent what may be referred to as a “venturi effect” when the inflatable curtain is inflated. The venturi effect may occur when an extremely short fill tube or no fill tube at all is used to inflate an inflatable curtain. In such a configuration, for example, the inflator/fill tube may extend just into or slightly beyond the neck portion 100 of the inflatable curtain. When the inflation fluid is directed into the curtain, the inflation fluid creates an area of high velocity, low pressure flow, which may cause a pressure drop in adjacent areas of the curtain.

For example, in the curtain arrangement of FIG. 2, if the fill tube 22 extended only into the neck portion 100, the high velocity, low pressure inflation fluid flow may be directed through the passage 96 toward the front portion 74 of the inflatable curtain 14. This might result in a pressure drop in the rear portion 76 of the inflatable curtain 14. The rear portion 76 would eventually pressurize as the inflator 22 continued to deliver inflation fluid into the curtain 14. In the meantime, however, the effectiveness of the rear portion might be reduced, depending on when the pressure drop occurred and how long it lasted. Therefore, it might be desirable to eliminate this initial pressure drop. The fill tube 22 of the present invention helps to eliminate the potential for an initial pressure drop by directing inflation fluid forward into the front portion 74 and downward into the rear portion 76 simultaneously and in the appropriate proportions.

From the above description of the invention, those skilled in the art will perceive improvements, changes and modifications. For example, in the illustrated embodiment, the inflator 24 is mounted on or near the C pillar 34, and the fill tube 22 extends into the rear portion 76 of the inflatable curtain 14. The inflator 24 could, however, be mounted on or near the A pillar 30, and the fill tube 22 would thus extend into the front portion 74 of the inflatable curtain 14, as illustrated in dashed lines in FIG. 2. In this configuration, the open end portion 110 would direct inflation fluid through the passage 96 into the rear portion 76, and the apertures 112 would direct inflation fluid into the front portion 74. Other such improvements, changes and modifications within the skill of the art are intended to be covered by the appended claims.

1. An apparatus for helping to protect an occupant of a vehicle that has a side structure and a roof, said apparatus comprising:
an inflatable curtain that is inflatable away from the vehicle roof to a position adjacent the side structure of the vehicle, said inflatable curtain comprising a front portion and a rear portion;
an inflation fluid source for providing inflation fluid for inflating said inflatable curtain; and
a fill tube for directing inflation fluid from said inflation fluid source into said inflatable curtain, said fill tube having a portion extending into one of said front and rear portions and terminating in said one of said front and rear portions, said fill tube having an open end portion for directing inflation fluid to flow axially from said fill tube into said inflatable curtain and at least one aperture for directing inflation fluid to flow generally radially from said fill tube into said inflatable curtain.

2. The apparatus recited in claim 1, wherein said open end portion directs inflation fluid into the other of said front and rear portions, said at least one aperture directing inflation fluid into said one of said front and rear portions.

3. The apparatus recited in claim 1, wherein said front portion of said inflatable curtain comprises at least one inflatable front chamber inflatable between the side structure and front seating of the vehicle, said rear portion of said inflatable curtain comprising at least one inflatable rear chamber inflatable between the side structure and rear seating of the vehicle.

4. The apparatus recited in claim 3, wherein said portion of said fill tube is positioned in said rear portion of said inflatable curtain, said open end portion directing inflation fluid into said front portion and into said at least one front chamber, said apertures directing said inflation fluid into said rear portion and into said at least one rear chamber.

5. The apparatus recited in claim 4, wherein said fill tube enters said inflatable curtain through a rear edge of said inflatable curtain at a location adjacent an upper edge of said inflatable curtain.

6. The apparatus recited in claim 4, wherein said open end portion of said fill tube is positioned in said rear portion adjacent a C pillar of the vehicle, said fill tube entering said inflatable curtain through a rear edge of said inflatable curtain at a location adjacent an upper edge of said inflatable curtain.

7. The apparatus recited in claim 3, wherein said portion of said fill tube is positioned in said front portion of said inflatable curtain, said open end portion directing inflation fluid into said rear portion and into said at least one rear chamber, said apertures directing said inflation fluid into said front portion and into said at least one front chamber.

8. The apparatus recited in claim 7, wherein said fill tube enters said inflatable curtain through a front edge of said inflatable curtain at a location adjacent an upper edge of said inflatable curtain.

9. The apparatus recited in claim 1, further comprising a non-inflatable portion disposed between said front and rear portions and a passage providing fluid communication between said front and rear portions, said open end portion of said fill tube directing inflation fluid through said passage into the other of said front and rear portions.

10. The apparatus recited in claim 9, wherein said portion of said fill tube has a length sufficient to position said open end portion near said passage.

11. The apparatus recited in claim 9, wherein said passage extends along an upper edge of said inflatable curtain above said non-inflatable portion.

12. The apparatus recited in claim 11, wherein said fill tube extends into said one of said front and rear portions along an upper edge of said inflatable curtain, said open end portion directing said inflation fluid along said upper edge into said passage.

13. The apparatus recited in claim 9, wherein said non-inflatable portion helps define said passage.

14. The apparatus recited in claim 1, wherein said portion of said fill tube has a length sufficient to extend along at least 25% of the length of said one of said front and rear portions.

15. The apparatus recited in claim 1, wherein said open end portion of said fill tube directs inflation fluid into said inflatable curtain in a direction generally parallel to a longitudinal axis of said fill tube, said at least one aperture directing inflation fluid into said inflatable curtain in a direction transverse to said longitudinal axis.

16. The apparatus recited in claim 15, wherein said direction transverse to said longitudinal axis is generally vertically downward in the vehicle.

17. The apparatus recited in claim 1, wherein said open end portion and said at least one aperture have flow areas that are proportional to the inflatable volume of the other of said front and rear portions and said one of said front and rear portions, respectively.

18. The apparatus recited in claim 1, wherein said fill tube comprises a metal fill tube, said inflatable curtain having at least one portion clamped to said fill tube.

19. An apparatus for helping to protect an occupant of a vehicle that has a side structure, a roof, front seating, and rear seating, said apparatus comprising:
an inflatable curtain that is inflatable away from the vehicle roof to a position adjacent the side structure of the vehicle, said inflatable curtain comprising at least one inflatable first chamber inflatable between the side structure and one of the front and rear seating, at least one inflatable second chamber inflatable between the side structure and the other of the front and rear seating, a non-inflatable portion positioned between said first and second chambers, and a passage providing fluid communication between said first and second chambers;
an inflation fluid source for providing inflation fluid for inflating said inflatable curtain; and
a fill tube for directing inflation fluid from said inflation fluid source into said inflatable curtain, said fill tube having a portion extending into said at least one second chamber and terminating in said at least one second chamber, said fill tube having an open end portion opposite said inflation fluid source for directing inflation fluid through said passage into said at least one first chamber, said fill tube including at least one aperture for directing inflation fluid in a generally downward direction into said at least one second chamber.

20. An apparatus for helping to protect an occupant of a vehicle that has a side structure and a roof, said apparatus comprising:
an inflatable curtain that is inflatable away from the vehicle roof to a position adjacent the side structure of the vehicle, said inflatable curtain comprising at least one inflatable front chamber inflatable between the side structure and a front seated occupant of the vehicle, at least one inflatable rear chamber inflatable between the side structure and a rear seated occupant of the vehicle, a non-inflatable portion positioned between said front and rear chambers, and a passage providing fluid communication between said front and rear chambers;
an inflation fluid source for providing inflation fluid for inflating said inflatable curtain; and
a fill tube for directing inflation fluid from said inflation fluid source into said inflatable curtain, said fill tube extending from said inflation fluid source into said at least one rear chamber and terminating in said at least one rear chamber, said fill tube having an open end portion opposite said inflation fluid source for directing inflation fluid through said passage into said at least one front chamber, said fill tube including at least one aperture for directing inflation fluid in a generally downward direction into said at least one rear chamber.

21. An apparatus for helping to protect an occupant of a vehicle that has a side structure and a roof, said apparatus comprising:
an inflatable curtain that is inflatable away from the vehicle roof to a position adjacent the side structure of the vehicle;
an inflation fluid source for providing inflation fluid for inflating said inflatable curtain; and
a fill tube for directing inflation fluid from said inflation fluid source into said inflatable curtain, said fill tube having an open end portion for directing an axial flow of inflation fluid from the fill tube into the inflatable curtain, said fill tube including at least one aperture for directing a generally radial flow of inflation fluid from the fill tube to help reduce pressure drop in the inflatable curtain induced by the axial flow of inflation fluid from said open end portion.
